(19) United States
(12) Patent Application Publication
(10) Pub. No.: US 2013/0306254 A1
(43) Pub. Date: Nov. 21, 2013

(54) DRIVING DEVICE FOR WINDOW BLIND ASSEMBLY

(71) Applicant: OMA AUTOMATION ENTERPRISE CO., LTD., Tainan City (TW)

(72) Inventors: HAO-TING CHEOU, TAINAN CITY (TW); YAO-CHING HUANG, TAINAN CITY (TW)

(73) Assignee: OMA AUTOMATION ENTERPRISE CO., LTD., TAINAN CITY (TW)

(21) Appl. No.: 13/654,585

(22) Filed: Oct. 18, 2012

(30) Foreign Application Priority Data
May 16, 2012 (TW) 101209244

(51) Int. Cl. E06B 9/28

(52) U.S. Cl. 160/176.1 P

(57) ABSTRACT

A window blind assembly includes a window frame and multiple slats are pivotably connected between two sides of the window frame. A driving plate is connected to the window frame and the slats are pivotably connected to the driving plate. An adjustment device has a case and a power unit is located in the case. The power unit is connected to an arm which has an elongate slot. A driven member is connected to the driving plate and has a guide rod which is movably engaged with the elongate slot. A control unit and a rechargeable battery are located in the case and respectively connected with the power unit. A solar power generating unit is connected to the control unit and the rechargeable battery. The angles of the slats are adjusted by the adjustment device via the power unit.

### BACKGROUND OF THE INVENTION

1. Field of the Invention

The present invention relates to a driving device for a window blind assembly and more particularly, to a driving device which is easily adjust the angle of the slats of the window blind assembly.

2. Description of Related Art

The conventional window curtains generally include window curtains, Roman shades, window blinds and honeycomb curtains. The window curtain is controlled to be lifted or lowered to adjust the light entering the interior of the room. The window blinds includes multiple slats, ropes extend through the slats and are connected with the control unit located in the head box. By operation of the control unit, the ropes collect the slats or release the slats.

The angles of the slats can be adjusted by operation the control rope or control wand. However, the user has to approach the window blinds to access the control rope or wand to adjust the slats. This is not convenient for some users and needs to be improved.

The present invention intends to provide electric window blind assembly which has an adjustment device powered by electric power so that the adjustment of the slats can be easily completed.

### SUMMARY OF THE INVENTION

The present invention relates to a window blind assembly and comprises a window frame and an adjustment device. The window frame has multiple slats pivotably connected between two sides thereof. A driving plate is connected to the window frame and the slats are pivotably connected to the driving plate. The adjustment device has a case and a power unit is located in the case. The power unit is connected to an arm which has an elongate slot. A driven member is connected to the driving plate and has a guide rod which is movably engaged with the elongate slot. A control unit and a rechargeable battery are located in the case and respectively connected with the power unit. A solar power generating unit is connected to the control unit and the rechargeable battery. The angles of the slats are adjusted by the adjustment device via the power unit.

The primary object of the present invention is to provide a driving device for a window blind assembly and the driving device easily adjusts the angle of the slats of the window blind assembly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the adjustment device of the window blind assembly of the present invention;

FIG. 2 is a perspective view to show the adjustment device and the window blind assembly of the present invention;

FIG. 3 is a perspective view to show the second embodiment of the adjustment device and the window blind assembly of the present invention;

FIG. 4 is a cross sectional view of the adjustment device of the window blind assembly of the present invention, and

FIG. 5 is a perspective view to show that the adjustment device of the window blind assembly of the present invention adjust the slats.

### DETAILED DESCRIPTION OF THE PREFERRED EMBODIMENT

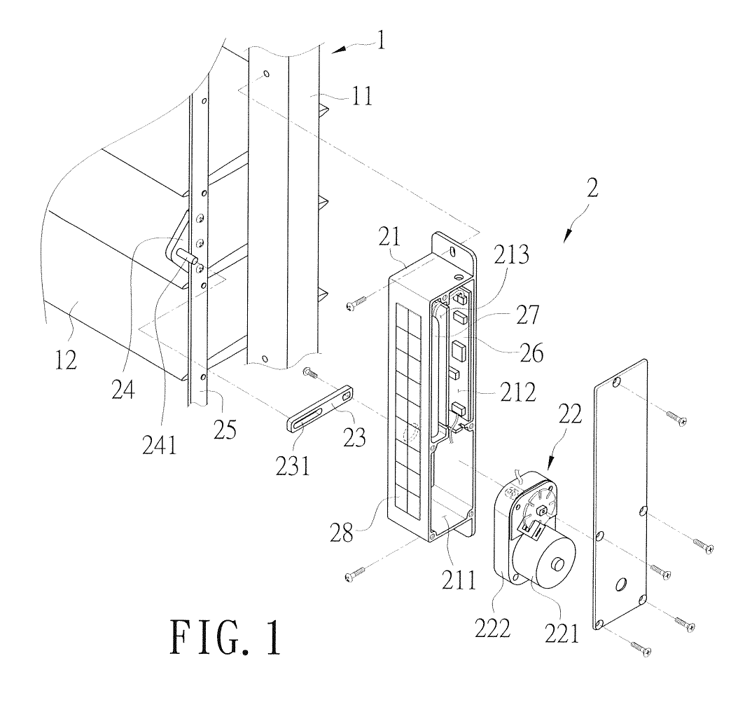

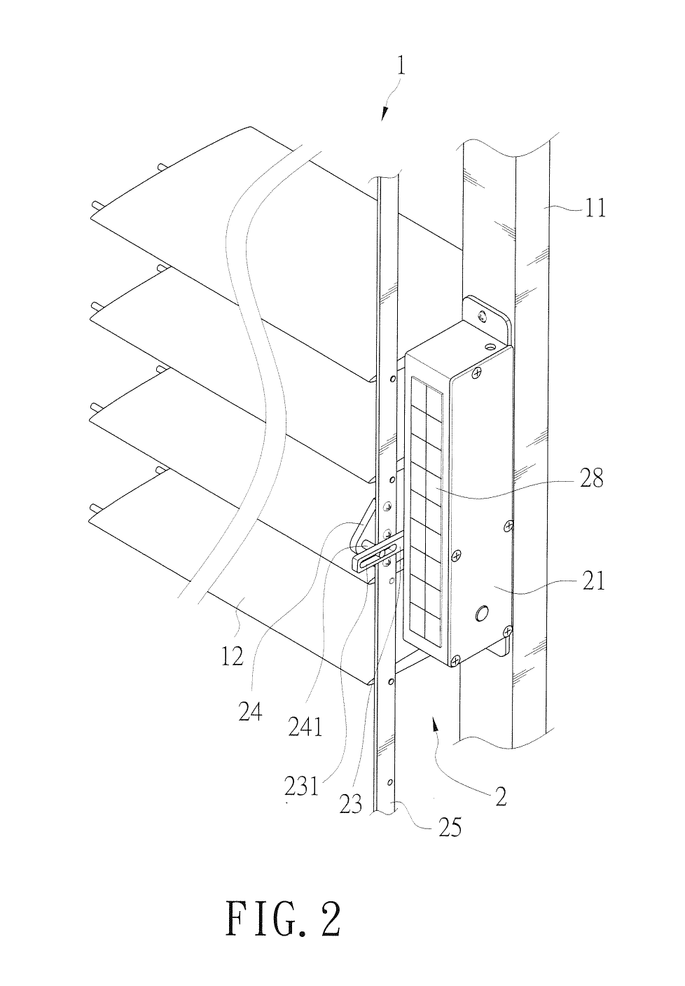

Referring to FIGS. 1 and 2, a window blind assembly 1 of the present invention comprises a window frame 11 and multiple slats 12 are pivotably connected between two sides of the window frame 11 by the mediate portion of each end of the slats 12. A driving plate 25 is connected to the window frame 11 and the slats 12 each are pivotably connected to the driving plate 25 by the respective corner thereof.

An adjustment device 2 has a case 21 and a driving power room 211 is defined in the case 21, a power unit 22 is located in the driving power room 211. The power unit 22 comprises a motor 221 which is connected with a speed reduction unit 222, or the power unit 22 is a Direct Current motor. The output end of the power unit 22 is connected to an arm 23 which has an elongate slot 231. A driven member 24 is connected to the driving plate 25 and has a guide rod 241 which is movably engaged with the elongate slot 231. The driven member 24 is fixed to the driving plate 25.

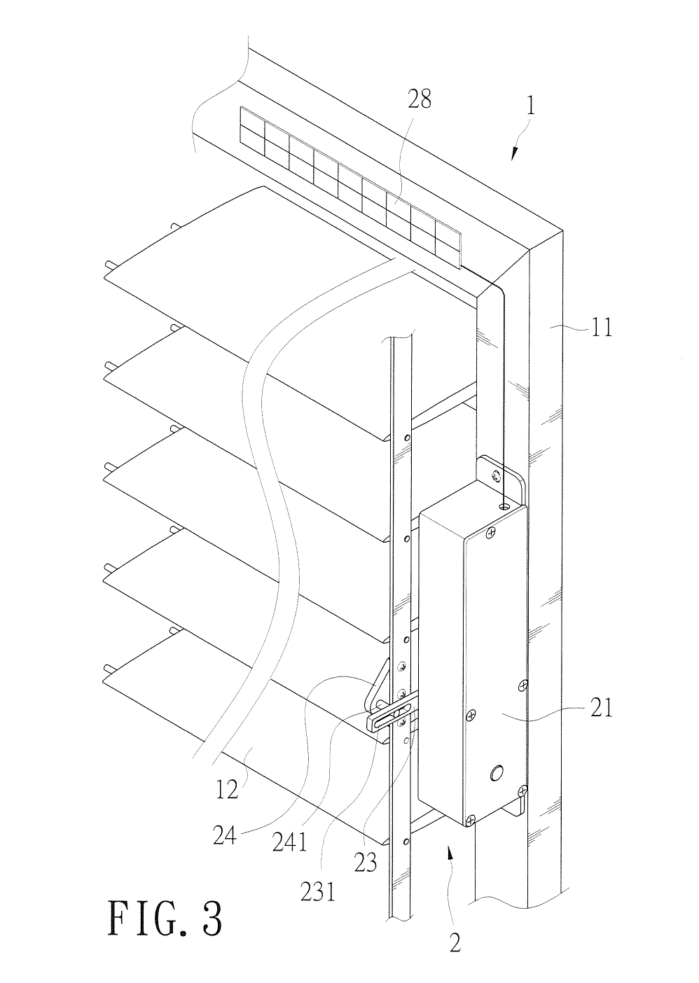

The case 21 has a control room 212 in which a control unit 26 is located. The control unit 26 is connected with the power unit 22 which is controlled by the control unit 26. The case 21 has an electric power room 213 in which a rechargeable battery 27 is located. The rechargeable battery 27 is connected with the control unit 26 so as to provide electric power to the control unit 26 and the power unit 22. A solar power generating unit 28 is connected to the rechargeable battery 27 via the control unit 26. The solar power generating unit 28 is located at a position of the case 21 of the window frame 11 where sufficient light or sun light is available as shown in FIG. 3. The solar power generating unit 28 transfers the sun light into electrical power which is stored in the rechargeable battery 27 via the control unit 26. The rechargeable battery 27 can be recharged by the solar power generating unit 28 or recharged by the city power.

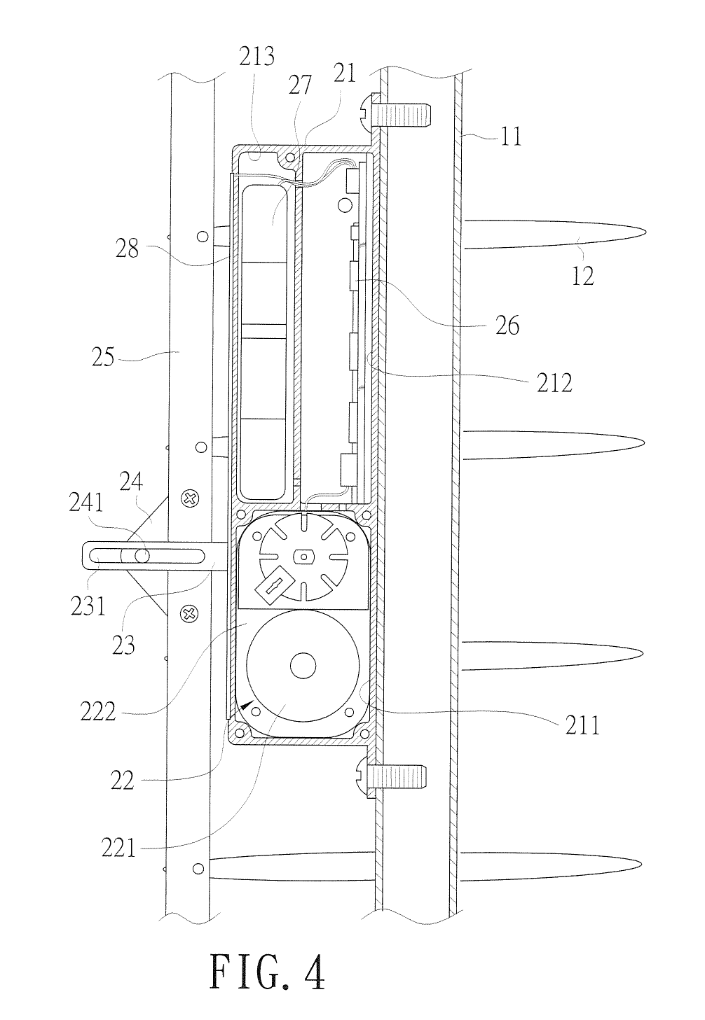

Further referring to FIG. 4, the case 21 of the adjustment device 2 is fixed to the window frame 11 and the slats 12 are pivotably connected to the driving plate 25.

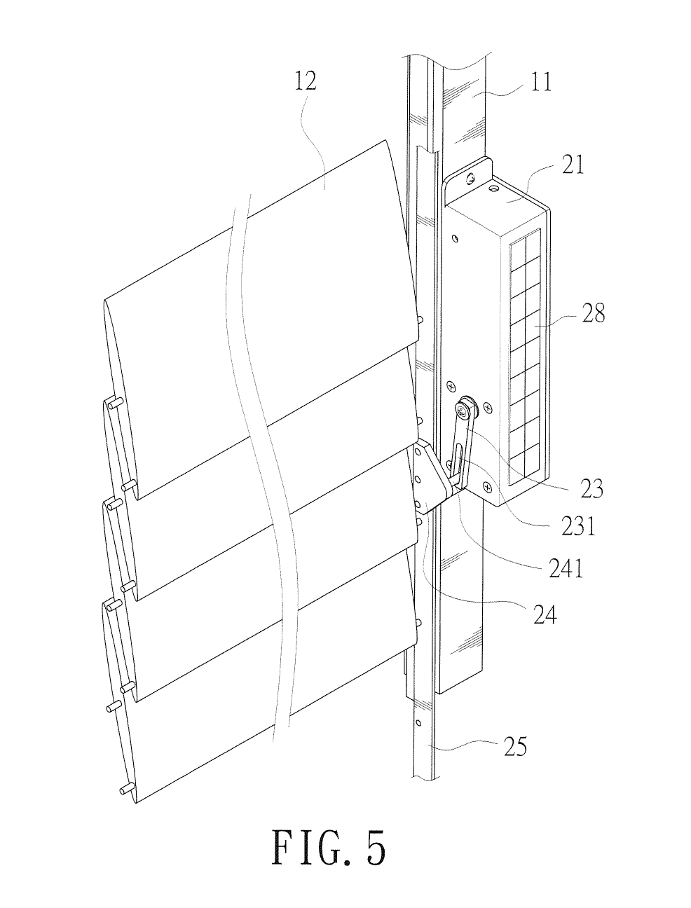

As shown in FIG. 5, by operation of the power unit 22 via the control unit 26 in the case 21, the arm 23 is driven to pivot upward or downward. The slats 12 are pivotably connected to the driving plate 25 and the window frame 11, the guide rod 241 is moved in the elongate slot 231 of the arm 23. In other words, the movement of the guide rod 241 moves the driving plate 25 up and down to pivot the slats 12 to adjust the angles of the slats 12.

The adjustment device uses electric power to adjust the angles of the slats 12 of the window blind assembly 1 and the users can easily operate the adjustment device when adjusting the slats 12.

While we have shown and described the embodiment in accordance with the present invention, it should be clear to those skilled in the art that further embodiments may be made without departing from the scope of the present invention.

What is claimed is:

1. A window blind assembly comprising:
a window frame and multiple slats pivotably connected between two sides of the window frame, a driving plate connected to the window frame and the slats pivotably connected to the driving plate, and
an adjustment device having a case and a power unit located in the case, the power unit connected to an arm which has an elongate slot, a driven member connected to the driving plate and having a guide rod which is movably engaged with the elongate slot, a control unit located in the case and connected with the power unit, a rechargeable battery located in the case and connected with the control unit, a solar power generating unit connected to the control unit and the rechargeable battery.

2. The window blind assembly as claimed in claim 1, wherein the adjustment device is fixed to the window frame.

3. The window blind assembly as claimed in claim 1, wherein the power unit comprises a motor which is connected with a speed reduction unit.

4. The window blind assembly as claimed in claim 1, wherein the power unit is a Direct Current motor.

5. The window blind assembly as claimed in claim 1, wherein the solar power generating unit is fixed to the case.

6. The window blind assembly as claimed in claim 1, wherein the solar power generating unit is located at a position with light.

7. The window blind assembly as claimed in claim 1, wherein the rechargeable battery is charged by city power via the control unit.

8. The window blind assembly as claimed in claim 1, wherein the case has a driving power room in which the power unit is located.

9. The window blind assembly as claimed in claim 1, wherein the case has a control room in which the control unit is located.

10. The window blind assembly as claimed in claim 1, wherein the case has an electric power room in which the rechargeable battery is located.
